(19) United States
(12) Patent Application Publication
(10) Pub. No.: US 2023/0151223 A1
(43) Pub. Date: May 18, 2023

(54) PIPELINE MEMBER FOR ULTRAPURE WATER AND POLYETHYLENE-BASED RESIN COMPOSITION FOR PIPELINE MEMBER FOR ULTRAPURE WATER

(71) Applicants: SEKISUI CHEMICAL CO., LTD., Osaka (JP); JAPAN POLYETHYLENE CORPORATION, Tokyo (JP)

(72) Inventors: Tomoki YAMADA, Kyoto (JP); Hirotsugu YOSHIDA, Kyoto (JP); Hirotaka TAKANO, Kyoto (JP); Tetsuya YOSHIKIYO, Kanagawa (JP); Tomoki HIRAMOTO, Kanagawa (JP)

(73) Assignees: SEKISUI CHEMICAL CO., LTD., Osaka (JP); JAPAN POLYETHYLENE CORPORATION, Tokyo (JP)

(21) Appl. No.: 17/913,633

(22) PCT Filed: Mar. 9, 2021
(86) PCT No.: PCT/JP2021/009334

§ 371 Date: Sep. 22, 2022

(30) Foreign Application Priority Data
Mar. 23, 2020 (JP) 2020-050969
Sep. 16, 2020 (JP) 2020-155810

(51) Int. Cl. C09D 5/08; F16L 9/133; C08F 210/02; C08K 5/13; C09D 123/08; C09D 7/63

(52) U.S. Cl. CPC C09D 5/086; F16L 9/133; C08F 210/02; C08K 5/13; C09D 123/0815; C09D 7/63

(57) ABSTRACT

A pipe (10) includes a polyethylene-based resin layer (21) containing a polyethylene-based resin composition as a major component. The polyethylene-based resin layer (21) forms a pipeline member inner surface (10a). The polyethylene-based resin composition has a calcium concentration of 10 ppm or more and 60 ppm or less.

### TECHNICAL FIELD

The present invention relates to a pipeline member for ultrapure water and a polyethylene-based resin composition for a pipeline member for ultrapure water. More specifically, the present invention relates to a polyethylene-based resin pipe, joint, valve, or the like, used as a pipeline member for ultrapure water, as well as a polyethylene-based resin composition for a pipeline member for ultrapure water.

### BACKGROUND ART

Conventionally, in the production of precision devices, such as semiconductor devices or liquid crystal display devices, ultrapure water, which is purified to extremely high purity, has been used in wet processes such as washing. The presence of metal ions or the like at a predetermined concentration or more adversely affects the qualities of precision devices dues to the attachment of metals on a wafer surface or the like, and therefore, impurities in ultrapure water are thoroughly limited.

Contamination of impurities into ultrapure water also occurs in pipelines configuring transfer lines of ultrapure water. Metals with excellent gas barrier properties, such as stainless steel, have been used as a material for pipelines in some cases, but the use of resins is considered preferable in consideration of the effect of metal elution from pipelines.

As a resin used in a material of a pipeline member for ultrapure water, fluorine resins, which are chemically inert, have gas barrier properties, and show extremely low elution to ultrapure water, have been used. For example, a fluorine resin double tube, in which two fluorine resin layers are laminated, may be mentioned as a pipeline used in a semiconductor production device, a liquid crystal production device, and other devices. Examples of fluorine resin double tubes may include a pipeline in which the inner layer tube is constituted of a fluorine resin with excellent corrosion resistance and chemical resistance (for example, a tetrafluoroethylene-perfluoroalkyl vinyl ether copolymer (PFA), a tetrafluoroethylene-hexafluoropropylene copolymer (FEP), or a tetrafluoroethylene-ethylene copolymer (ETFE)) and the outside layer tube is constituted of a fluorine resin that can suppress gas permeation (for example, polyvinylidene fluoride (PVDF)).

In addition, PTL 1 discloses a multi-layer pipe for a pipeline of ultrapure water, including a first resin layer made from a fluorine resin and in contact with ultrapure water and a second resin layer made from a gas impermeable resin and disposed on the outer periphery of the first resin layer. Furthermore, PTL 1 describes that a third resin layer for protecting the second resin layer is disposed on the outer periphery of the second resin layer, and polyethylene is used as the third resin layer.

Among resins used as a material for pipeline members for ultrapure water, polyvinylidene fluoride (PVDF) is used in pipelines in ultrapure water production apparatuses and all pipelines that have been put to practical use as pipelines for transporting ultrapure water from an ultrapure water production apparatus to use points in the semiconductor field, and has become the technological standard in pipeline members for ultrapure water.

Recently, circuit patterns are becoming finer and finer with the increase of the degree of integration of semiconductor chips and becoming more susceptible to low level impurities. Accordingly, water quality requirements for ultrapure water are becoming increasingly stringent. For example, a regulation relating to the quality, etc., of ultrapure water used in semiconductor productions has been published as the SEMI F75 and is renewed every two years.

### CITATION LIST

### Patent Literature

[PTL 1] Japanese Patent Application Publication No. 2010-234576

### SUMMARY OF INVENTION

A pipeline made of a fluorine resin such as PVDF has some disadvantages in terms of workability and cost, compared to other common pipelines. However, against the background of increasingly more stringent water quality requirements for ultrapure water, pipelines made of fluorine resins have become actually the only option for pipelines that meet the required water quality.

The present inventors dared to focus on substituting the materials for pipeline members for ultrapure water. For example, polyethylene-based resins, which are excellent in workability and cost, have been used as common pipeline members. However, polyethylene-based resins used as general-purpose pipeline members are synthesized by polymerization using a chlorine-containing catalyst like a Ziegler catalyst, and mixing a neutralizing agent, such as calcium stearate, is required to neutralize the catalyst residues after the polymerization. Furthermore, since fatty acid metal soaps, such as calcium stearate, among neutralizing agents, exhibit an effect of neutralizing chlorine and also exhibit a lubricating effect on a mold, it is common to mix, in a pipeline member, a fatty acid metal soap as a smoothness improver on the pipeline member surface, irrespective of the type of polymer catalysts of polyethylene. Thus, since calcium derived from a neutralizing agent is eluted out into transported water in a common polyethylene-based resin pipe, the quality of the transported water is far from the required water quality for ultrapure water.

The present invention has an object to provide a pipeline member for ultrapure water, which can reduce the calcium elution amount and has sufficient mechanical properties as a pressure pipe system, and a polyethylene-based resin composition for a pipeline member for ultrapure water.

### Solution to Problem

The present inventors have made intensive studies and, as a result, have found that, regarding a polyethylene-based resin pipeline member, the calcium elution amount can be greatly reduced, and long-term strength can also be exhibited by controlling the calcium concentration in a polyethylene resin in contact with ultrapure water on the inner wall side of the pipeline member to a specific range and, if a phenol antioxidant is added, controlling the structure of the phenol antioxidant to a specific type, thereby achieving the present invention.

That is, the present invention provides an invention of aspects listed below.

A pipeline member for ultrapure water according to a first aspect includes a layer that contains a polyethylene-based resin as a major component, the layer forming a pipeline member inner surface and the layer having a calcium concentration of 10 ppm or more and 60 ppm or less.

A pipeline member for ultrapure water according to a second aspect is the pipeline member for ultrapure water according to the first aspect, wherein the polyethylene-based resin is a polyethylene-based resin polymerized using a Ziegler catalyst.

A pipeline member for ultrapure water according to a third aspect is the pipeline member for ultrapure water according to the first or second aspect, wherein the layer contains an antioxidant.

A pipeline member for ultrapure water according to a fourth aspect is the pipeline member for ultrapure water according to the third aspect, wherein the antioxidant includes a phenolic antioxidant free of oxygens derived from anything other than phenol groups.

A pipeline member for ultrapure water according to a fifth aspect is the pipeline member for ultrapure water according to the fourth aspect, wherein the antioxidant includes a phenolic antioxidant containing oxygen derived from anything other than phenol groups, and the layer has a calcium concentration of 50 ppm or less.

A pipeline member for ultrapure water according to a sixth aspect is the pipeline member for ultrapure water according to any one of the first to fifth aspects, wherein the layer is substantially free of photostabilizers.

A pipeline member for ultrapure water according to a seventh aspect is the pipeline member for ultrapure water according to any one of the first to sixth aspects, wherein the layer shows an oxidation induction time at 210° C. of 20 minutes or longer.

A pipeline member for ultrapure water according to an eighth aspect is the pipeline member for ultrapure water according to any one of the first to seventh aspects, wherein a total organic carbon amount eluted from the layer is 30000 μg/m² or less.

A pipeline member for ultrapure water according to a ninth aspect is the pipeline member for ultrapure water according to any one of the first to eighth aspects, wherein the layer has a thickness of 0.3 mm or larger.

A pipeline member for ultrapure water according to a tenth aspect is the pipeline member for ultrapure water according to any one of the first to ninth aspects, wherein the layer has a thickness of 2.0 mm or smaller.

A pipeline member for ultrapure water according to an eleventh aspect is the pipeline member for ultrapure water according to any one of the first to tenth aspects, which does not cause destruction for 3,000 hours or longer in a state where circumferential stress of 5.0 MPa is applied to the pipeline member for ultrapure water at 80° C.

A polyethylene-based resin composition for a pipeline member for ultrapure water according to the twelfth aspect includes a polyethylene-based resin and satisfies following characteristics (1) to (5):

characteristic (1): a melt flow rate (MFR_{21.6}) at a temperature of 190° C. and a load of 21.6 kg being 6 g/10 min or more and 25 g/10 min or less;

characteristics (2): FR (MFR_{21.6}/MFR₅), i.e., a ratio of MFR_{21.6} to a melt flow rate (MFR₅) at a load of 5 kg, being 25 or more and 60 or less;

characteristics (3): a high molecular weight component (A) and a low molecular weight component (B) being included, the high molecular weight component (A) showing an MFR_{21.6} of 0.05 g/10 min or more and 1.0 g/10 min or less, an α-olefin content that excludes ethylene being 0.8 mol % or more and 2.0 mol % or less and a content proportion of α-olefins that excludes ethylene in relation to the entire resin being 35 wt % or more and 50 wt % or less, the low molecular weight component (B) showing a melt flow rate (MFR₂) at a temperature of 190° C. and a load of 2.16 kg of 20 g/10 min or more and 500 g/10 min or less;

characteristics (4): a density being 0.946 g/cm³ or more and 0.960 g/cm³ or less; and

characteristics (5): a calcium concentration being 10 ppm or more and 60 ppm or less.

A polyethylene-based resin composition for a pipeline member for ultrapure water according to a thirteenth aspect is the polyethylene-based resin composition for a pipeline member for ultrapure water according to the twelfth aspect, wherein the polyethylene-based resin is a polyethylene-based resin polymerized using a Ziegler catalyst.

A polyethylene-based resin composition for a pipeline member for ultrapure water according to a fourteenth embodiment is the polyethylene-based resin composition for a pipeline member for ultrapure water according to the twelfth or thirteenth embodiment, which contains an antioxidant.

A polyethylene-based resin composition for a pipeline member for ultrapure water according to a fifteenth aspect is the polyethylene-based resin composition for pipeline a material for ultrapure water according to the fourteenth aspect, wherein the antioxidant includes a phenolic antioxidant free of oxygens derived from anything other than phenol groups.

A polyethylene-based resin composition for a pipeline member for ultrapure water according to a sixteenth aspect is the polyethylene-based resin composition for pipeline a material for ultrapure water according to the fourteenth aspect, wherein the antioxidant includes a phenolic antioxidant containing oxygen derived from anything other than phenol groups, and a calcium concentration is 50 ppm or less.

A polyethylene-based resin composition for a pipeline member for ultrapure water according to a seventeenth aspect is the polyethylene-based resin composition for pipeline a material for ultrapure water according to any one of the twelfth to sixteenth aspects, which is substantially free of photostabilizers.

A polyethylene-based resin composition for a pipeline member for ultrapure water according to an eighteenth aspect is the polyethylene-based resin composition for a pipeline member for ultrapure water according to any one of the twelfth to seventeenth aspects, which shows an oxidation induction time at 210° C. of 20 minutes or longer.

### Advantageous Effects of Invention

According to the present invention, it is possible to provide a pipeline member for ultrapure water, which can reduce the calcium elution amount and has sufficient mechanical properties, and a polyethylene-based resin composition for a pipeline member for ultrapure water.

### BRIEF DESCRIPTION OF DRAWINGS

FIG. 1 is a schematic cross-sectional view illustrating a pipe of one example of a pipeline member for ultrapure water of an embodiment of the present invention.

FIG. 2 is a schematic cross-sectional view illustrating a pipe of another example of a pipeline member for ultrapure water of an embodiment of the present invention.

FIG. 3A is a view illustrating a joint of one example of a pipeline member for ultrapure water of an embodiment of the present invention.

FIG. 3B is a view illustrating a joint of one example of a pipeline member for ultrapure water of an embodiment of the present invention.

FIG. 3C is a view illustrating a joint of one example of a pipeline member for ultrapure water of an embodiment of the present invention.

FIG. 3D is a view illustrating a joint of one example of a pipeline member for ultrapure water of an embodiment of the present invention.

FIG. 3E is a view illustrating a joint of one example of a pipeline member for ultrapure water of an embodiment of the present invention.

FIG. 4 is a view illustrating a valve of one example of a pipeline member for ultrapure water of an embodiment of the present invention.

FIG. 5 is a structural formula of Irganox 1010.

FIG. 6 is a structural formula of Irganox 1330.

### DESCRIPTION OF EMBODIMENTS

Hereinafter, a pipeline member for ultrapure water of an embodiment of the present invention will be described. However, a pipeline member for ultrapure water is a generic term for components constituting pipelines for ultrapure water and includes pipes, joints, valves, and other components.

[Pipe Structure]

Hereinafter, a pipe of the present embodiment is described.

The pipe of the present embodiment is provided with a polyethylene-based resin layer forming the inner surface of the pipe and containing a polyethylene-based resin as a major component. If necessary, a coated resin layer may be disposed outside the polyethylene-based resin layer.

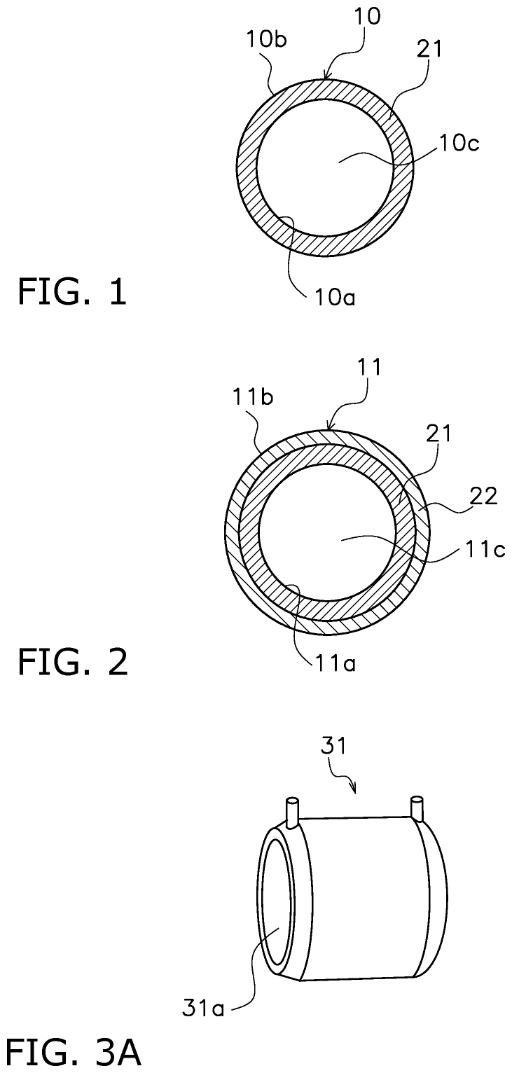

FIG. 1 is a schematic cross-sectional view illustrating one example of a pipe of the present embodiment. FIG. 2 is a schematic cross-sectional view illustrating another example of a pipe of the present embodiment.

The pipe 10 (one example of the pipeline member for ultrapure water) illustrated in FIG. 1 is provided with a polyethylene-based resin layer 21 (one example of the layer). The pipe 11 (one example of the pipeline member for ultrapure water) illustrated in FIG. 2 is provided with a polyethylene-based resin layer 21 forming the innermost layer and a coated resin layer 22 disposed outside the polyethylene-based resin layer 21.

The pipe 10 illustrated in FIG. 1 is formed by a polyethylene-based resin layer 21. The polyethylene-based resin layer 21 forms the inner surface 10a (an example of the pipeline member inner surface) of the pipe 10. Furthermore, in the pipe 10 illustrated in FIG. 1, the outer surface 10b is also formed by a polyethylene-based resin layer 21. The polyethylene-based resin layer 21 is formed in a tubular shape so as to configure the pipe 10.

In the pipe 11 illustrated in FIG. 2, the polyethylene-based resin layer 21 forms the inner surface 11a (an example of the pipeline member inner surface) of the pipe 11. In the pipe 11 illustrated in FIG. 2, the outer surface 11b is formed by a coated resin layer 22. The polyethylene-based resin layer 21 is formed in a tubular shape so as to configure the innermost layer of the pipe 11. The coated resin layer 22 is formed in a tubular shape so as to cover the polyethylene-based resin layer 21.

Furthermore, in the pipe 11 illustrated in FIG. 2, only one coated resin layer 22 is disposed outside the polyethylene-based resin layer 21, but the number of layers of the coated resin layer 22 is not particularly limited and may be one or two or more.

The inner surfaces 10a and 11a face the channels 10c and 11c inside the pipes 10 and 11, respectively, and are considered surfaces that can be in contact with ultrapure water.

[Joint Structure]

Hereinafter, joints of the present embodiment are described.

Although not particularly limited, the joints of an embodiment of the present invention may be a socket, an elbow, a tee, a flange, or the like.

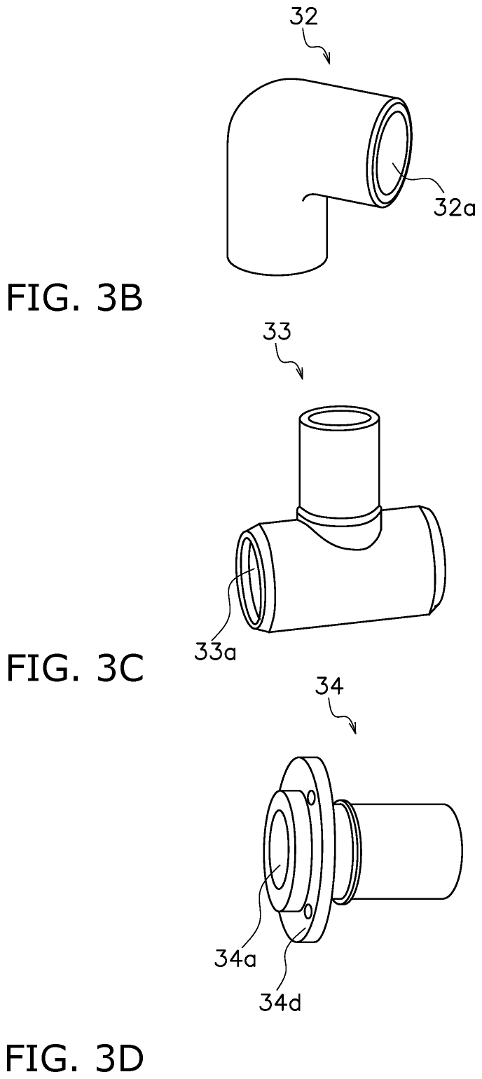

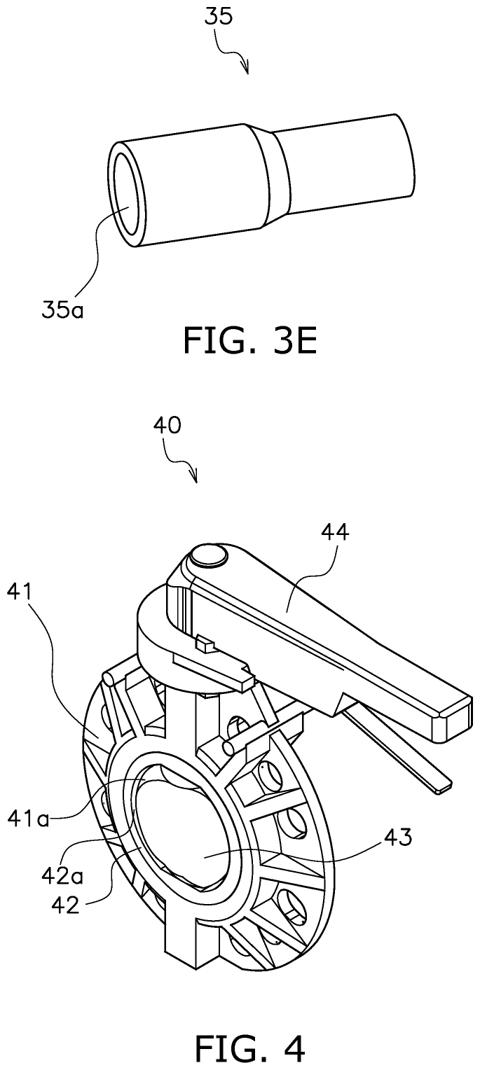

FIGS. 3A to 3E are views illustrating examples of the joints of the present embodiment.

The joint 31 illustrated in FIG. 3A is a socket, and pipes are inserted from both ends of the joint, and the joint connects the portion between two pipes in a straight line. For example, the joint 31 is an electrofusion joint.

The joint 32 illustrated in FIG. 3B is an elbow and connects pipes at right angles, for example.

The joint 33 illustrated in FIG. 3C is a tee. The joint 33 connects three pipes at 90 degrees intervals.

The joint 34 illustrated in FIG. 3D is a flange. The joint 34 has a flange portion 34d and is connected to a valve or the like.

The joint 35 illustrated in FIG. 3E is a reducer. The joint 35 connects two pipes with different diameters on a straight line.

The structure of the pipe mentioned above may be applied to the structures of the joints 31 to 35 illustrated in FIGS. 3A to 3E, and the joints 31 to 35 have sectional shapes similar to the pipe structure mentioned above (see FIGS. 1 and 2). That is, the joints 31 to 35 all have a polyethylene-based resin layer 21 forming the inner surfaces 31a to 35a facing the channel. A coated resin layer 22 may be disposed outside the polyethylene-based resin layer 21.

[Valve Structure]

Hereinafter, a valve of the present embodiment is described.

Although not particularly limited, examples of the valve of the present embodiment may include a diaphragm valve, a ball valve, a butterfly valve, a globe valve, a gate valve, a check valve, and the like.

FIG. 4 is a view illustrating a butterfly valve as one example of a valve. The butterfly valve 40 illustrated in FIG. 4 includes a valve casing 41, a sheet ring 42, a valve rod (not shown), a valve body 43, and a handle 44. The valve casing 41 is disposed between the pipe members through which fluid flows. A through hole is formed on the valve casing 41. The sheet ring 42 is fitted to the inner peripheral surface of the through hole of the valve casing 41. The valve body 43 is fixed to the valve rod and rotated with the rotation of the valve rod and compresses the sheet ring 42 to close the channel 41a formed inside the sheet ring 42. It should be noted that the valve rod is rotated by turning the handle 44.

The structure of the pipe mentioned above may be applied to the structures of the sheet ring 42 mentioned above, and the sheet ring 42 has a sectional shape similar to the pipe structure mentioned above (see FIGS. 1 and 2). That is, the sheet ring 42 has a polyethylene-based resin layer 21 forming the inner surfaces 42a facing the channel 41a. A coated resin layer 22 may be disposed outside the polyethylene-based resin layer 21.

[Polyethylene-Based Resin Layer]

The polyethylene-based resin layer 21 (one example of the layer) contains a polyethylene-based resin as a major component. The major component refers to a component with the largest content on a mass basis. The major component is a component with a content of at least 50%. The lower limit of the polyethylene-based resin content in the polyethylene-based resin layer is preferably 50 mass %, more preferably 70 mass %, and further preferably 80 mass %, and may particularly preferably be 90 mass %, and may still more preferably be 95 mass %.

The polyethylene-based resin may be copolymerized with an α-olefin as needed. Examples of the α-olefins copolymerized with the polyethylene-based resin may include propylene, 1-butene, 1-pentene, 1-hexene, 4-methyl-1-pentene, 1-octene, 1-butene 1-hexene, 1-butene 4-methyl-1-pentene, 1-butene 1-octene, and the like.

The polyethylene-based resin is polymerized using a catalyst containing one or more transition metal derivatives. From the viewpoint of ensuring long-term durability, the polymerization is conducted using a Ziegler catalyst in the present embodiment. When the polyethylene-based resin is polymerized using a Ziegler catalyst, a chlorine-containing catalyst is used in an amount that would be determined, as appropriate, by a person skilled in the art, then multi-stage polymerization is performed, and thereafter, a neutralizing agent for neutralizing the chlorine-containing catalyst and, preferably, an antioxidant are additionally added.

The Ziegler catalyst used in the present invention is a well-known one, and for example, catalyst systems disclosed in published unexamined patent applications such as Japanese Patent Application Publications Nos. S53-78287, S54-21483, S55-71707, and S58-225105 may be used.

Specifically, a catalyst system composed of an organic aluminum compound and a solid catalyst component obtained by bringing a co-pulverization product obtained by co-pulverizing an aluminum trihalide, an organic silicon compound with Si—O bonds, and magnesium alcoholate into contact with a tetravalent titanium compound may be mentioned.

The solid catalyst component preferably contains 1 to 15 wt % titanium atoms. Preferable organic silicon compounds include organic silicon compounds having a phenyl group or aralkyl group, such as dimethoxydiphenylsilane, trimethoxyphenylsilane, triethoxyphenylsilane, ethoxytriphenylsilane, methoxytriphenylsilane, and the like.

When the co-pulverization product is produced, the used proportion of the aluminum trihalides and organic silicon compounds per mole of magnesium alcoholate are each generally 0.02 to 1.0 mole, and particularly preferably 0.05 to 0.20 mole. The proportion of aluminum atoms in aluminum trihalide in relation to silicon atoms in organic silicon compounds is suitably 0.5 to 2.0 in terms of molar ratio.

For producing a co-pulverization product, a normally performed method using a pulverizer commonly used in producing this kind of solid catalyst components, such as a rotating ball mill, a vibrating ball mill, and a colloid mill, should be applied. The average particle diameter of the resulting co-pulverization product is normally 50 to 200 and the specific surface area thereof is 20 to 200 m²/g.

A solid catalyst component can be obtained by bringing the thus-obtained co-pulverization product into contact with a tetravalent titanium compound in a liquid phase. The organic aluminum compound used in combination with the solid catalyst component is preferably a trialkylaluminum compound, and for example, may be triethylaluminum, tri-n-propylaluminum, tri-n-butylaluminum, tri-i-butylaluminum, and the like.

Examples of neutralizing agents may include fatty acid metal salts represented by calcium stearate, zinc stearate, and magnesium stearate, and hydrotalcite.

However, polymerization of the polyethylene-based resin using magnesium stearate or hydrotalcite as a neutralizing agent is not preferable for the present embodiment because a large amount of aluminum or magnesium elutes into the water from a pipeline member obtained by molding the resulting resin.

In contrast, calcium stearate is a preferable neutralizing agent in the present embodiment because metal elution of aluminum and magnesium as described above does not occur, and good low elutability can be achieved when the polyethylene-based resin is polymerized using calcium stearate as a neutralizing agent.

The polyethylene-based resin composition is preferably high density polyethylene (HDPE) because pressure-resistant performance with respect to the water pressure at the time of water supply is sufficient and the thickness of the pipe can be thin. Among high density polyethylenes (HDPE), HDPE classified as a pressure-resistant class of PE 100 or better in ISO 9080, ISO 1167, and ISO 12162 is more preferred from the viewpoint of ensuring the long-term durability of a pipeline member for ultrapure water. Furthermore, among HDPEs classified as a pressure-resistant class of PE 100 or better, a HDPE with high resistance to slow crack growth (slow crack growth resistance) for further enhancing the safety of pipe systems and high fluidity so that the smoothness of the pipe inner surface is better. It should be noted that the slow crack growth refers to a form of failure caused by stress concentration to scratches on a pipeline member, a connection part between a pipe and a joint, or the like.

Specifically, as an index of the polyethylene-based resin composition with good fluidity, satisfying the resistance class of PE 100 or better, it is preferred that the melt flow rate (MFR_{21.6}) at a temperature of a polyethylene-based resin composition of 190° C. and a load of 21.6 kg is 6 g/10 min or more and 25 g/10 min or less, the FR (MFR_{21.6}/MFR₅), which is a ratio of MFR_{21.6} to the melt flow rate (MFR₅) at a temperature of 190° C. and a load of 5 kg, is 25 or more and 60 or less, and the density is 0.946 g/cm³ or more and 0.960 g/cm³ or less.

If the MFR_{21.6} of the polyethylene-based resin composition is less than 6 g/10 min, the fluidity of the resin material is low, and the mold transfer property becomes poor, and the smoothness on the pipe inner surface is insufficient. In contrast, if the MFR_{21.6} exceeds 25 g/10 min, resin designs for satisfying PE 100 are difficult. If the FR is less than 25, the molecular weight distribution of the polyethylene-based resin composition is narrow, and it becomes difficult to achieve both the target MFR_{21.6} and slow crack resistance. In contrast, if the FR exceeds 60, the impact resistance of the polyethylene-based resin composition may decrease, and the safety of the pipeline member may be impaired. If the density is less than 0.946 g/cm³, the pressure-resistant performance decreases, making it difficult to reach PE 100. In contrast, if the density exceeds 0.960 g/cm³, the slow crack growth resistance of a pipe material decreases, and the safety of the pipe system decreases during long-term use.

Furthermore, as a specific resin composition for achieving the polyethylene-based resin composition mentioned above, the resin composition composed of multiple components of a high molecular weight component (A) and a low molecular weight component (B) is preferred.

The high molecular weight component (A) has an MFR_{21.6} of 0.05 g/10 min or more and 1.0 g/10 min or less, and preferably 0.1 g/10 min or more and 0.5 g/10 min or less, an α-olefin content excluding ethylene of 0.8 mol % or more and 2.0 mol % or less, and preferably 0.9 mol % or more and 1.6 mol % or less, and the content ratio of the high molecular weight component (A) in relation to the entire resin composition is 35 wt % or more and 50 wt % or less, and preferably 37 wt % or more and 43 wt % or less. Meanwhile, the low molecular weight component (B) has a melt flow rate (MFR₂) at a temperature of 190° C. and a load of 2.16 kg of 20 g/10 min or more and 500 g/10 min or less, and preferably 50 g/10 min or more and 300 g/10 min or less.

If the MFR_{21.6} of the high molecular weight component (A) constituting the polyethylene-based resin composition is less than 0.05 g/10 min, the MFR of the low molecular weight component is required to be increased in order to achieve the target MFR_{21.6}, but in such a case, the difference in viscosity between the high molecular weight component and the low molecular weight component at melting is large, which leads to the reduction in compatibility, and as a result, various mechanical properties, including slow crack resistance, are degraded, and the inner surface of the pipeline is roughened due to flow instability. Meanwhile, if the MFR_{21.6} exceeds 1.0 g/10 min, various mechanical properties are degraded, and among them, slow crack growth resistance is greatly degraded. If the α-olefin content is less than 0.8 mol %, slow crack growth resistance is degraded, and if it exceeds 2.0 mol %, the stiffness of the polyethylene-based resin composition decreases, which makes the resin design to achieve PE 100 difficult. If the content ratio of the high molecular weight component (A) is less than 35 wt %, the durability of the pipeline is degraded, and if it exceeds 50 wt %, the stiffness of the polyethylene-based resin composition decreases, which makes the resin design to achieve PE 100 difficult.

If the MFR₂ of the low molecular weight component (B) constituting the polyethylene-based resin composition is less than 20 g/10 min, the fluidity of the polyethylene-based resin composition is low and the mold transfer property becomes poor, and the smoothness on the pipe inner surface is insufficient. In contrast, if MFR₂ exceeds 500 g/10 min, a reduction in various mechanical properties is observed, and among them, a reduction in impact resistance becomes larger.

The α-olefin content used herein contains not only α-olefin fed in a reactor and copolymerized upon polymerization but also short-chain branches (for example, ethyl branches and methyl branches). The α-olefin content is measured by 13C-NMR. The α-olefin content can be increased or decreased by increasing or decreasing the supplying amount of the α-olefin to be copolymerized with ethylene.

The calcium concentration in the polyethylene-based resin layer 21 is 60 ppm or less, preferably 55 ppm or less, and further preferably 50 ppm or less. If the calcium concentration exceeds 60 ppm, the calcium elution amount into ultrapure water becomes excess, and the required quality of ultrapure water cannot be satisfied.

From the viewpoint of further reducing the amount of calcium elution into ultrapure water, the calcium concentration in the polyethylene-based resin layer 21 is preferably as small as possible, but presence of a trace of calcium is unavoidable for achieving good thermal stability and long-term strength of the polyethylene-based resin composition.

That is, if the addition amount of a neutralizing agent added to the polyethylene-based resin polymerized using a Ziegler catalyst is insufficient, the catalyst residues remain active in a resin, and the thermal stability and the long-term strength of the polyethylene-based resin composition may be degraded.

Accordingly, it is essential to add the minimum amount of a neutralizing agent in order to neutralize the catalyst residues in the present embodiment. In consideration of the above state, the calcium concentration in the polyethylene-based resin layer 21 is 10 ppm or more, preferably 13 ppm or more, more preferably 15 ppm or more, and further preferably 20 ppm or more.

The oxidation induction time (OIT) at 210° C. of the polyethylene-based resin layer 21 is preferably 20 minutes or longer from the viewpoint of ensuring thermal stability. If the oxidation induction time at 210° C. is shorter than 20 minutes, the resin may deteriorate when the polyethylene-based resin is thermally processed, and the long-term strength may be degraded, or the particles derived from the degradation product may increase, which is unfavorable as the present embodiment.

As an evaluation method for the long-term strength when the polyethylene-based resin is used as a pipeline member, a hot internal pressure creep test has been widely used. From the viewpoint of sufficiently ensuring the long-term strength of the pipeline member for ultrapure water, the hot internal pressure creep performance when the polyethylene-based resin layer 21 is molded into a pipeline member is preferably such that the pipeline member does not break for 3,000 hours or longer when a circumferential stress of 5.0 MPa is loaded on the pipeline member at 80° C.

The polyethylene-based resin composition preferably has material characteristics such that the pressure-resistant performance meets the requirement for “PE 100” or better as defined in the regulations of ISO 9080, ISO 1167, and ISO 12162. It should be noted that the “PE 100” refers to polyethylene with an LPL value, which is a value obtained by measuring stress-breaking time curves for at least 9,000 hours at three different temperature levels where the maximum temperature and the minimum temperature are at least 50° C. apart and estimating the minimum guaranteed stress after 50 years at 20° C. by extrapolation using multiple correlation averaging, of 10 MPa or more and 11.19 MPa or less in the classification table defined in ISO 12162.

The polyethylene-based resin layer 21 may or may not contain an antioxidant. Examples of antioxidants may include a phenolic antioxidant, a phosphorus-based antioxidant, a sulfur-based antioxidant, an aromatic amine-based antioxidant, a lactone-based antioxidant, and the like.

Examples of phenolic antioxidants may include pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, N,N′-hexane-1,6-diylbis[3-(3,5-di-tert-butyl-4-hydroxyphenyl)propionamide], benzenepropanoic acid, 3,5-bis(1,1-dimethylethyl)-4-hydroxy, C7-C9 side chain alkyl esters, 3,3′,3″,5,5′,5″-hexa-tert-butyl-a,a′,a″-(mesitylene-2,4,6-triyl)tri-p-cresol, 4,6-bis(dodecylthiomethyl)-o-cresol, 4,6-bis(octyltiomethyl)-o-cresol, ethylene bis(oxyethylene)bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylyl)methyl]-1,3,5-triazine-2,4,6(1H,3H,5H)-trione, 2,6-di-tert-butyl-4-[4,6-bis(octylthio)-1,3,5-triazine 2-ylamino]phenol, diethyl[{3,5-bis(1,1-dimethylethyl)-4-hydroxyphenyl}methyl]hosphonate, and the like.

When a phenolic antioxidant is used, only one type may be used, or two or more types may be used in combination. However, from the viewpoint of preventing calcium elution, it is preferred that the phenolic antioxidant is free of oxygens derived from anything other than phenol groups, and examples thereof may include 3,3′,3″,5,5′,5″-hexa-tert-butyl-a,a′ a″-mesitylene-2,4,6-triyl)tri-p-cresol, 2,6-di-tert-butyl-4-[4,6-bis(octylthio)-1,3,5-triazin-2-ylamino]phenol, 4,4′,4″-(1-methylpropanyl-3-ylidene)tris(6-tert-butyl-m-cresol), 6,6′-di-tert-butyl-4,4′-butylidenebis-m-cresol, and the like. When a phenolic antioxidant containing oxygen derived from anything other than phenol groups is used as an antioxidant, the calcium concentration in the polyethylene-based resin is preferably 50 ppm or less. Examples of functional groups containing oxygen derived from anything other than phenol groups may include an ester group, a carbonyl group, a carboxy group, an ether group, a nitro group, a nitroso group, an amide group, an ajxy group, a sulfo group, and the like.

Examples of phosphorus-based antioxidants may include tris(2,4-di-tert-butylphenyl)phosphite, tris[2-[2,4,8,10-tetra-tert-butyldibenzo[d,f][1,3,2]dioxaphosphephin-6-yl]oxy]ethyl]amine, bis(2,4-di-tert-butylphenyl)pentaerythritol diphosphite, bis[2,4-bis(1,1-dimethylethyl)-6-methylphenyl]ethyl ester phosphite, tetrakis(2,4-di-tert-butylphenyl) (1,1-biphenyl)-4,4′-diylbisphosphonite, and the like.

Examples of sulfur-based antioxidants may include dilaurylthiodipropionate, dimyristylthiodipropionate, di stearylthiodipropionate, pentaerythritol tetrakis(3-laurylthiopropionate), and the like.

Examples of aromatic amine-based antioxidants may include monoamine compounds such as diphenylamine-based compounds, quinoline-based compounds, and naphthylamine-based compounds and diamine compounds such as phenylene diamine-based compounds and benzoimidazole-based compounds.

Examples of diphenylamine-based compounds may include p-(p-toluenesulfonylamide)-diphenylamine, 4,4′-(a,a-dimethylbenzyl)diphenylamine, 4,4′-dioctyldiphenylamine derivatives, and the like.

Examples of quinoline-based compounds may include a 2,2,4-trimethyl-1,2-dihydroquinoline polymer.

Examples of naphthylamine-based compounds may include phenyl-α-naphthylamine, N,N′-di-2-naphthyl-p-phenylenediamine, and the like.

Examples of phenylene diamine-based compounds may include N—N′-diphenyl-p-phenylenediamine, N-isopropyl-N′-phenyl-p-phenylenediamine, N-phenyl-N′-(3-methacryloyloxy-2-hydroxypropyl)-p-phenylenediamine, N-phenyl-N′-(1,3-dimethylbutyl)-p-phenylenediamine, a mixture of N—N′-diphenyl-p-phenylenediamine, diaryl-p-phenylenediamine derivatives or mixtures thereof, and the like.

Examples of benzoimidazole-based compounds may include 2-mercaptobenzoimidazole, 2-mercaptomethylbenzoimidazole, a zinc salt of 2-mercaptobenzoimidazole, a zinc salt of 2-mercaptomethylbenzoimidazole, and the like.

Examples of lactone-based antioxidants may include reaction products between 3-hydroxy-5,7-di-tert-butyl-furan-2-one and o-xylene, and the like.

The antioxidant content in the polyethylene-based resin layer 21 is, for example, 0.01 wt % or more, preferably 0.03 wt % or more, and more preferably 0.05 wt % or more from the viewpoint of reducing the effect by oxygen and ensuring preferable strength, and as the upper limit, the antioxidant content is, for example, 5 wt % or less, preferably 1 wt % or less, and more preferably 0.5 wt % or less.

The polyethylene-based resin layer 21 may or may not contain a photostabilizer, but it is preferred to contain no photostabilizer from the viewpoint of preventing total organic carbon (TOC) elution. Examples of photostabilizers may include hindered amine-based photostabilizer (HALS), and the like. It is preferred that the polyethylene-based resin layer 21 of the present embodiment contains substantially no photostabilizer. Here, “contains substantially no photostabilizer” means that photostabilizers are not positively added, and inevitable contamination as an impurity is allowed. The concentration of an inevitably contaminating photostabilizer as an impurity is preferably as low as possible, but, for example, may be 600 ppm or less. The value of 600 ppm is the HALS value corresponding to the allowable amount of TOC elution, 30000 μg/m² (shown below), roughly derived from Examples and Comparative Examples shown in (Table 3) below. Specifically, the value 600 ppm was determined by connecting, by a straight line, the relationship between 6500 μg/m², which was a mean TOC elution amount at a HALS addition amount of 0 ppm in Examples 1, 3, and 4 in (Table 3), and 46000 μg/m², which was a TOC elution amount at a HALS addition amount of 1000 ppm in Comparative Example 1, and roughly estimating the HALS addition amount corresponding to a TOC elution amount of 30000 μg/m².

Examples of hindered amine-based photostabilizers may include NH-type hindered amine compounds, N—R-type hindered amine compounds, and N—OR-type hindered amine compounds.

Examples of N—H-type hindered amine compounds may include Tinuvin 770 DF, Chimassorb 2020 FDL, Chimassorb 944 FDL (all trade names, manufactured by BASF SE), Adekastab LA-68, Adekastab LA-57 (both trade names, manufactured by Adeka Corp.), Cyasorb UV-3346, Cyasorb UV-3853 (both trade names, manufactured by Sun Chemical Co., Ltd.), and the like.

Examples of N—R-type hindered amine compounds may include Tinuvin 622 SF, Tinuvin 765, Tinuvin PA 144, Chimassorb 119, Tinuvin 111 (all trade names, manufactured by BASF SE), Sabostab UV 119 (trade name, manufactured by Sabo S.p.A.), Adekastab LA-63P, Adekastab LA-52 (both trade names, manufactured by Adeka Corp.), and the like.

Examples of N—OR-type hindered amine compounds may include Tinuvin 123, Tinuvin 5100, Tinuvin NOR 371 FF, Flamestab NOR 116 FF (all trade names, manufactured by BASF SE), and the like.

The polyethylene-based resin layer 21 may or may not contain a UV absorber (UVA). Examples of UV absorbers may include benzophenone-based UV absorbers, salmalate-based UV absorbers, benzocoat-based UV absorbers, benzotriazole-based UV absorbers, cyanoacrylate-based UV absorbers, quenchers, and the like. As UV absorbers, benzophenone-based UV absorbers and benzotriazole-based UV absorbers are particularly preferred for polyethylene or polypropylene.

Examples of benzophenone-based UV absorbers may include 2-hydroxy-4-methoxy-benzophenone and the like.

Examples of benzotriazole-based UV absorbers may include 2-(2-hydroxy-5-methylphenyl)benzotriazole (Sumisorb 200, manufactured by Sumika Chemtex Co., Ltd.), 2-(2-hydroxy-5-t-butyl-5-methylphenyl)-5-chlorobenzotriazole (Tinuvin 326, manufactured by BASF SE), 2-(2-hydroxy-3,5-di-t-butylphenyl)-5-chlorobenzotriazole (Tinuvin 327, manufactured by BASF SE), 2-(2-hydroxy-3,5-di-t-amyl phenyl)benzotriazole (Tinuvin 328, manufactured by BASF SE), and the like.

The density of the polyethylene-based resin composition of the polyethylene-based resin layer 21 may be preferably 0.946 g/cm³ or more, more preferably 0.947 g/cm³ or more, further preferably 0.948 g/cm³ or more, from the viewpoint of achieving good resin composition stiffness. In addition, the density may be preferably 0.960 g/cm³ or less, more preferably 0.957 g/cm³ or less, further preferably 0.953 g/cm³ from the viewpoint of achieving good long-term durability and flexibility of the polyethylene-based resin composition. The density is a value established in accordance with JIS K 6922-2:1997.

The melt flow rate (MFR_{21.6}) at a temperature of 190° C. and a load of 21.6 kg of the polyethylene-based resin composition of the polyethylene-based resin layer 21 may be 6 g/10 min or more and 25 g/10 min or less. The MFR_{21.6} may be preferably 8 g/10 min or more, more preferably 12 g/10 min or more, and further preferably 15 g/min or more from the viewpoint of achieving good processability of the polyethylene-based resin composition. Furthermore, the MFR_{21.6} may be preferably 22 g/10 min or less and more preferably 20 g/10 min or less from the viewpoint of achieving good long-term durability of a resin. MFR_{21.6} is a value established in accordance with JIS K 6922-2:1997.

The smoothness (arithmetic mean roughness Ra) of the inner surface of the polyethylene-based resin layer 21 is not particularly limited and, for example, 0.50 μm or less. From the viewpoint of achieving good low elution of the pipeline, the smoothness of the inner surface of the polyethylene-based resin layer 21 is preferably 0.40 μm or less and more preferably 0.35 μm or less.

The thickness of the polyethylene-based resin layer 21 of the innermost surface when a coated resin layer 22 is disposed outside the polyethylene-based resin layer 21 of the innermost layer that forms the inner surfaces 11a, 31a to 35a, and 42a (examples of the pipeline member inner surface) of the pipeline member for ultrapure water is preferably 0.3 mm or more and more preferably 0.4 mm or more in consideration of the strength of the entire pipeline member for ultrapure water, the calcium concentration in the coated resin layer 22, or the like. The upper limit of the thicknesses is preferably 2.0 mm or less and more preferably 1.5 mm or less.

The thickness of the polyethylene-based resin layer 21 when a coated resin layer 22 is not disposed outside the polyethylene-based resin layer 21 that forms the inner surfaces 10a, 31a to 35a, and 42a (examples of the pipeline member inner surface) of the pipeline member for ultrapure water is not particularly limited, and regarding the lower limit of the thickness, the thickness is, for example, 0.3 mm or more.

[Coated Resin Layer]

The type of the coated resin layer 22 is not particularly limited, and may be a polyethylene-based resin layer made of a polyethylene-based resin, or a gas barrier resin layer made of a gas barrier resin, or a combination of these.

When a polyethylene-based resin layer is disposed as the coated resin layer 22, the polyethylene-based resin may be selected, as appropriate, among the polyethylene-based resin compositions that are the major component of the innermost polyethylene-based resin layer 21 mentioned above.

Among the polyethylene-based resins listed above, high-density polyethylene (HDPE) is preferred from the viewpoint of reducing the elution of low molecular weight components and/or durability when pipes are washed with chemicals.

The polyethylene-based resin that is the major component of the polyethylene-based resin layer of the coated resin layer 22 may be the same kind as or different kind from the polyethylene-based resin composition that is the major component of the innermost polyethylene-based resin layer 21, but when both layers are laminated in contact with each other, a polyethylene-based resin of the same type is more preferable from the viewpoint of improving the adhesiveness of both layers and developing desirable strength.

The polyethylene-based resin layer in the coated resin layer 22 preferably contains an antioxidant. Examples of antioxidants may include a phenolic antioxidant, a phosphorus-based antioxidant, a sulfur-based antioxidant, an aromatic amine-based antioxidant, a lactone-based antioxidant, and the like. The antioxidant content in the polyethylene-based resin layer in the coated resin layer 22 may be, for example, 0.01 wt % or more and preferably 0.1 wt % or more from the viewpoint of reducing the effect by oxygen and ensuring preferable strength, and regarding the upper limit, the antioxidant content is, for example, 5 wt % or less, preferably 1 wt % or less, and more preferably 0.5 wt % or less.

When a gas barrier layer is disposed as the coated resin layer 22, the gas barrier layer should be laminated outside the polyethylene-based resin layer 21 of the innermost layer. The gas barrier layer may constitute the outermost layer of the pipeline member for ultrapure water (for example, the pipe 11), or another layer may be disposed further outside the gas barrier layer.

It is preferable to dispose a gas barrier layer because gas dissolution in ultrapure water can be suppressed well by disposing a gas barrier layer. The gas barrier layer prevents oxygen from the outer surface 11b of the pipeline member for ultrapure water (for example, the pipe 11) from penetrating into the innermost polyethylene-based resin layer 21, or the outer polyethylene-based resin layer disposed as necessary, and thus can also improve the long-term strength of the pipeline member for ultrapure water (for example, the pipe 11).

Disposing the gas barrier layer prevents oxygen from the outer surface 11b of the pipeline member for ultrapure water (for example, the pipe 11) from penetrating into the innermost polyethylene-based resin layer 21, or the outer polyethylene-based resin layer disposed as necessary, and thus can also improve the strength of the pipeline member for ultrapure water (for example, the pipe 11). In addition, it is also preferable to dispose a gas barrier layer because gas dissolution in ultrapure water can be suppressed well.

Examples of materials for the gas barrier layer may include polyvinyl alcohol (PVA), an ethylene-vinyl alcohol copolymer (EVOH), a polyvinylidene chloride resin (PVDC), polyacrylonitrile (PAN), and the like, and polyvinyl alcohol (PVA) and an ethylene-vinyl alcohol copolymer (EVOH) are preferred.

The thickness of the gas barrier layer is not particularly limited as long as it is thick enough to ensure at least the gas barrier property of the polyethylene-based resin, and may be, for example, 30 to 300 preferably 50 to 250 and more preferably 70 to 250 μm.

[Use of Pipeline member for Ultrapure Water]

The pipeline member for ultrapure water of an embodiment according to the present invention is used for transporting ultrapure water. Specifically, the pipeline member for ultrapure water of an embodiment according to the present invention can be used as pipelines in an ultrapure water production apparatus, pipelines for transporting ultrapure water from an ultrapure water production apparatus to a use point, pipelines for returning ultrapure water from a use point, and the like. The ultrapure water in the present invention is defined as water with a specific resistance at 25° C. of 10 MΩ·cm or more, more strictly water with a specific resistance at 25° C. of 15 MΩ·cm or more, and further strictly water with a specific resistance at 25° C. of 18 MΩ·cm or more.

The pipeline member for ultrapure water of an embodiment according to the present invention is preferably used in pipelines for nuclear power generation, where the water quality requirements for ultrapure water are particularly stringent, or in the manufacturing process of pharmaceutical products, or in pipelines for transporting ultrapure water used in a wet treatment step, such as washing, in the manufacturing process of semiconductor devices or liquid crystals, or more preferably, in the manufacturing process of semiconductor devices. Even for such semiconductor devices, those with a higher degree of integration are preferred, and specifically, those used in the manufacturing process of semiconductor devices with a minimum line width of 65 nm or less are more preferable. Examples of a regulation relating to the quality, etc., of ultrapure water used in semiconductor productions include SEMI F75.

The pipeline member for ultrapure water of an embodiment according to the present invention has a polyethylene-based resin layer and is therefore excellent in workability. For example, fusion bonding work such as butt fusion bonding and EF (electrofusion) bonding can be easily performed at relatively low temperatures.

[Production of Pipeline Member for Ultrapure Water]

The pipeline member for ultrapure water of an embodiment according to the present invention may be produced by preparing a polyethylene-based resin that is a major component of the polyethylene-based resin layer 21 that forms the inner surfaces 10a, 11 a, 31a to 35a, and 42a and optionally a coating resin that constitutes the outside coated resin layer 22, and co-extruding them so that the thickness of each layer becomes the predetermined thickness. The pipeline member for ultrapure water of an embodiment according to the present invention is made of a polyethylene-based resin and therefore can be produced at a low cost.

### EXAMPLES

The invention is described in more detail below with examples, but the invention is not limited to these examples.

### [Examples 1 to 4], [Comparative Examples 1 and 2]

The following evaluation was performed using the following materials.

### (Antioxidant)

Irganox 1010 (manufactured by BASF Japan Ltd.)

Irganox 1330 (manufactured by BASF Japan Ltd.)

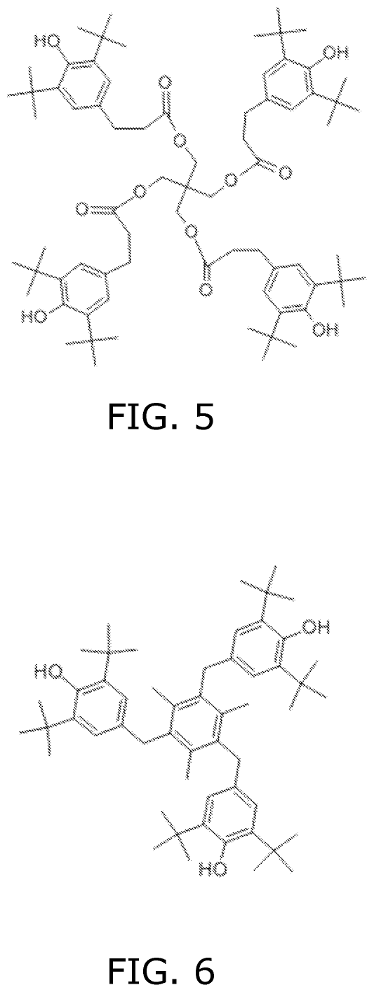

FIG. 5 is a view illustrating the structural formula of Irganox 1010. FIG. 6 is a view illustrating the structural formula of Irganox 1330.

### (1) Polymerization of Polyethylene-Based Resin

### (Preparation of Solid Catalyst Component)

A pot (vessel for pulverization) with an internal volume of 1 L, containing about 700 magnetic balls with a diameter of 10 mm, was charged with 20 g of commercially available magnesium ethylate (average particle diameter: 860 μm), 1.66 g of granular aluminum trichloride, and 2.72 g of diphenyldiethoxysilane under a nitrogen atmosphere. These were co-pulverized for 3 hours using a vibrating ball mill in a condition of an amplitude of 6 mm and a vibration frequency of 30 Hz. After co-pulverizing, the contents were separated from the magnetic balls under a nitrogen atmosphere.

To a 200-ml three-necked flask, 5 g of the resulting co-pulverized product and 20 ml of n-heptane were added. While stirring, 10.4 ml of titanium tetrachloride was added dropwise at room temperature, the temperature was raised to 90° C., and stirring was continued for 90 minutes. The reaction system was then cooled, the supernatant liquid was extracted, and n-hexane was added. This operation was repeated three times. The resulting light yellow solid was dried under reduced pressure at 50° C. for 6 hours to obtain a solid catalyst component.

### (Production of Polyethylene Resin Composition)

In a first polymerization liquid-filled loop reactor with an internal volume of 100 L, dehydrated and purified isobutane at a rate of 63 L/hr, triisobutylaluminum at a rate of 20 g/hr, and the solid catalyst mentioned above at a rate of 3.6 g/hr, and ethylene at a rate of 7 kg/hr were continuously fed, and hydrogen (control of MFR)) and 1-hexene (control of α-olefin content), as a comonomer, were added so as to achieve the target MFR_{21.6} and comonomer content, and copolymerization of ethylene and 1-hexene was carried out at 85° C., a polymerization pressure of 4.3 MPa, and an average residence time of 0.9 hours. A portion of the polymerization reaction product was collected and measured for physical properties. As a result, MFR_{21.6} was 0.2 g/10 min, and the α-olefin content was 1.2 mol %.

Next, the whole amount of the isobutane slurry containing the first step polymerization product was introduced directly into the second step reactor with an internal volume of 200 L, and the polymerization of the second step was carried out under the conditions where isobutane was supplied at a rate of 40 L/hr, ethylene was supplied at a rate of 7 kg/hr, the temperature was 85° C., the polymerization pressure was 4.2 MPa, and the average residence time was 0.9 hours, without adding a catalyst. In this second step, hydrogen and 1-hexene were supplied so as to produce essentially the same polymer as in the first process. A portion of the polymerization reaction product after the second step was collected and measured for physical properties. As a result, MFR_{21.6} was 0.2 g/10 min, and the α-olefin content was 1.2 mol %.

Next, the whole amount of the isobutane slurry containing the second step polymerization product was introduced directly into the 400-L third step reactor, and isobutane at a rate of 87 L/hr and ethylene at a rate of 18 kg/hr were continuously supplied without adding a catalyst and 1-hexene, then hydrogen was added so as to achieve the target MFR_{21.6}, and the polymerization of the third step was carried out at a temperature of 90° C., a polymerization pressure of 4.1 MPa, and an average residence time of 1.5 hours. The polyethylene-based polymer discharged from the third step reactor was dried, and the resulting polymerized powder was melt-kneaded with the prescribed additives to prepare a polyethylene-based resin composition. The measurement of the polyethylene-based resin composition found that MFR_{21.6} was 18 g/10 min, the density was 0.951 g/cm³, and the α-olefin content was 0.5 mol %. The percentages of the polymers (high molecular weight component (A)) produced in the first and second steps were both 20 wt %.

Meanwhile, the MFR of the polyethylene-based polymer of the low molecular weight component (B) produced in the third step was determined by separately performing polymerization under the polymerization conditions of the third step. The MFR was 130 g/10 min. The α-olefin content of the polyethylene-based polymer of the low molecular weight component produced in the third step was 0.1 mol %, which was determined using the fact that the additivity relating to weight percent between the α-olefin content after the third step and the α-olefin content after the second step is established. The results are shown in (Table 1).

The polymers produced in the first and second steps were combined to form the high molecular weight component (A), and the polymer produced in the third step was used as the low molecular weight component (B).

TABLE 1

| | | | Polyethylene-based resin |
|---|---|---|---|
| | | Unit | composition |
| High-molecular | MFR21.6 | g/10 min | 0.2 |
| weight | α-olefin content | mol % | 1.2 |
| component (A) | Blending ratio | wt % | 40 |
| Low-molecular | MFR2 | g/10 min | 130 |
| weight | α-olefin content | mol % | 0.1 |
| component (B) | Blending ratio | wt % | 60 |
| Total | MFR5 | g/10 min | 0.4 |
| | MFR21.6 | g/10 min | 18 |
| | FR | — | 45 |
| | Density | g/cm³ | 0.951 |
| | α-olefin content | mol % | 0.5 |

### (2) Preparation of Polyethylene-Based Resin Composition Sheet

In this example, various evaluations were performed in sheet forms rather than pipe forms.

Polyethylene-based resin pellets were heat-pressed at 200° C. for 3 minutes according to the formulation shown in (Table 2) below into a sheet of 180 mm×180 mm×1 mm to produce a test sample.

### (3) Evaluation of Calcium Concentration

A 0.1-g weight test specimen was prepared by cutting the above sheet, and then fed to a microwave decomposition system (MARS 6, manufactured by CEM Corp.) with 6 mL of nitric acid to decompose the test specimen by microwave irradiation. After decomposition, 1 mL of hydrogen peroxide was added, and ultrapure water was further added to adjust the volume to 25 mL. The calcium concentration of the solution was measured by an ICP apparatus (SPS 5100, manufactured by SII Technology Inc.), and the calcium concentration of the polyethylene-based resin composition sheet was calculated.

### (4) Evaluation of Calcium Elution Amount

Three sheets were prepared by cutting the above sheet into 30 mm×50 mm samples. The samples were washed with ultrapure water by a method according to the SEMI F40 standard. After washing, the samples were enclosed in a PFA container with 100 mL of ultrapure water. The PFA container was then allowed to stand at 85° C.±5° C. for 7 days for elution, and then an ICP-MS device (model No. Agirent 7500cs, manufactured by Agilent Technologies, Inc.) was used to measure the calcium elution amount. The standard value to be met for the calcium elution amount was set at 15 μg/m² or less. (Table 2) shows the results.

### (5) Evaluation of Oxidation Induction Time (OIT)

The oxidation induction times (OIT) of the above sheets were measured using a differential scanning calorimeter (DSC). DSC 7020, manufactured by Seiko Instruments Inc., was used for the measurements. After placing 5 mg of the sheet in the furnace of the device, the inner lid was closed, and the temperature was raised to 210° C. at a temperature raising rate of 20° C./min while nitrogen gas was flown at a rate of 50 mL/min, and then left in the same state for 5 minutes. After standing still, nitrogen was switched to oxygen to oxidize the sample. The oxidation induction time was measured by calculating the period from the time at which the nitrogen was switched to oxygen to the onset of the exothermic peak due to oxidation. The standard value to be met for the oxidation induction time was set at 20 minutes or longer.

The oxidation induction time is closely related to the thermal stability and long-term strength of the sample, and the longer the oxidation induction time, the better the thermal stability and long-term strength. (Table 2) shows the results.

TABLE 2

| | | | | | | | Comparative | |
|---|---|---|---|---|---|---|---|---|
| | | | Examples | | | | Example | |
| | | | 1 | 2 | 3 | 4 | 1 | 2 |
| Sample Shape | | | Flat sheet | Flat sheet | Flat sheet | Flat sheet | Flat sheet | Flat sheet |
| Formulation | Calcium concentration | | 40.1 | 30.2 | 44.1 | 32.4 | 75.3 | 3.8 |
| | (ppm) | | | | | | | |
| | Phenolic | Type | Irganox | Irganox | Irganox | Irganox | Irganox | Irganox |
| | antioxidant | | 1010 | 1010 | 1330 | 1330 | 1010 | 1010 |
| | | Added | 1000 | 1000 | 1000 | 1000 | 1000 | 1000 |
| | | part (ppm) | | | | | | |

| | | | | | | | |
|---|---|---|---|---|---|---|---|
| Performance | Calcium elution amount | 10.5 | 5.8 | 6.3 | 3.9 | 19.0 | 1.8 |
| | (μg/m²) | | | | | | |
| | Oxidation induction time at | 39.1 | 29.1 | 37.8 | 25.3 | 39.4 | 0.2 |
| | 210° C. (min) | | | | | | |

As shown in the table above, when the calcium concentration of the polyethylene-based resin composition sheet was 10 ppm or more and 60 ppm or less (Examples 1 to 4), the calcium elution amount was less than 15 μg/m², which indicated that calcium elution could be effectively suppressed, and thermal stability could also be exhibited.

In contrast, when the calcium concentration in the polyethylene-based resin composite sheet was 60 ppm or higher (Comparative Example 1), the calcium elution amount exceeded 15 μg/m².

In addition, as shown in the comparison between Example 1 and Example 3, and between Example 2 and Example 4, even if the calcium concentration in the polyethylene-based resin is the same degree, the calcium elution amount is more reduced when Irganox 1330 is added as a phenolic antioxidant than when Irganox 1010 is added. The cause of this phenomenon is speculated as follows.

That is, since Irganox 1010 has oxygen derived from anything other than phenol groups in the molecule thereof, the molecular polarity is higher, and Irganox 1010 easily elutes out of the polyethylene-based resin. Furthermore, intermolecular forces are prone to act between Irganox 1010 and calcium components due to the high polarity of Irganox 1010, and the elution of the calcium component may be induced when Irganox 1010 is eluted. That is, the calcium component is also considered to be more easily eluted when Irganox 1010 is added.

On the contrary, Irganox 1330 has no oxygen derived from anything other than phenol groups and is a less polar molecule, and is presumed not to be involved in the elution of calcium components.

Based on the above results, when a phenolic antioxidant is added, it is preferable that the antioxidant has no oxygen derived from anything other than phenolic groups from the viewpoint of reducing the calcium elution amount.

In addition, it is found that when a phenolic antioxidant containing oxygen derived from anything other than a phenol group is used as an antioxidant, the calcium concentration in the polyethylene-based resin is preferably 50 ppm or less.

As shown in Comparative Example 2, when the calcium concentration of the polyethylene-based resin composition synthesized using a Ziegler catalyst was below 10 ppm, the amount of calcium elution was reduced, but the oxidation induction time was less than 20 minutes, and the thermal stability was insufficient. This is thought to be because the Ziegler catalyst remaining in the resin after polymerization of the polyethylene-based resin was not sufficiently neutralized, and active catalyst residues remained in the resin, resulting in the reduction of thermal stability. Therefore, when a polyethylene-based resin synthesized using a Ziegler catalyst is used as a pipeline member for ultrapure water, the calcium concentration must be at least 10 ppm from the viewpoint of exhibiting thermal stability.

### (6) TOC Elution Amount

Three sheets were prepared by cutting the above sheet into 30 mm×50 mm samples. The samples were washed with ultrapure water by a method according to the SEMI F40 standard. After washing, the samples were enclosed in a PFA container with 100 mL of ultrapure water. The PFA container was then allowed to stand at 85° C.±5° C. for 7 days for elution, and then a total organic carbon meter (model number TOC-5000, manufactured by Shimadzu Corporation) was used to measure the TOC eluted amount. The standard value to be met for the TOC elution amount was set to 30000 μg/m² or less, which is half of the required condition of the TOC elution amount (60000 μg/m² or less) written in the SEMI F57 standard. (Table 3) shows the results.

In (Table 3), sheet-shaped test samples in Examples 1, 3, and 4 listed in (Table 2), where HALS was not added, and a sheet-shaped test sample in Comparative Example 1, where HALS was added in the formulation in (Table 3), were used.

TABLE 3

| | | | | | | Comparative |
|---|---|---|---|---|---|---|
| | | | Examples | | | Example |
| | | | 1 | 3 | 4 | 1 |
| Sample Shape | | | Flat sheet | Flat sheet | Flat sheet | Flat sheet |
| | Calcium concentration (ppm) | | 40.1 | 30.2 | 44.1 | 75.3 |
| Formulation | Phenolic | Type | Irganox 1010 | Irganox 1330 | Irganox 1330 | Irganox 1010 |
| | antioxidant | Added part | 1000 | 1000 | 1000 | 1000 |
| | | (ppm) | | | | |

| | | | | | |
|---|---|---|---|---|---|
| Performance | HALS (ppm) | 0 | 0 | 0 | 1000 |
| | TOC elution amount (μg/m²) | 7100 | 5600 | 7000 | 46000 |

As shown in (Table 3), it is found from Example 1 and Comparison Example 1 that the TOC elution amount exceeds the standard value when photostabilizers are included. In addition, Examples 1, 3, and 4 also show that when no photostabilizer is included, the TOC elution amount is within the standard value, irrespective of the kinds of the phenolic antioxidant.

### Examples 5 to 8

Pipeline members (elbows and pipes) were molded using the polyethylene-based resin compositions in (Table 1), and the following evaluations were performed. This test is described in more detail below, but the invention is not limited to these examples.

### (1) Evaluation of Elbow

### (1-1) Molding of Elbow

Elbows with a bore diameter of 25 A (see FIG. 3B) were injection-molded according to the formulation shown in (Table 4). Elbows are molded by a normal molding method.

### (1-2) Evaluation of Calcium Concentration

A 0.1-g weight test specimen was prepared by cutting the above elbow, and then fed to a microwave decomposition system (MARS 6, manufactured by CEM Corp.) with 6 mL of nitric acid to decompose the test specimen by microwave irradiation. After decomposition, 1 mL of hydrogen peroxide was added, and ultrapure water was further added to adjust the volume to 25 mL. The calcium concentration of the solution was measured by an ICP apparatus (SPS 5100, manufactured by SII Technology Inc.), and the calcium concentration of the polyethylene-based resin elbow was calculated.

### (1-3) Evaluation of Calcium Elution Amount

After the sample washing of the above elbow with ultrapure water according to the method based on the SEMI F40 standard, 80 mL of ultrapure water was placed in the elbow, and the end was sealed. The elbows were then allowed to stand at 85° C.±5° C. for 7 days for elution, and then an ICP-MS device (model No. Agirent 7500cs, manufactured by Agilent Technologies) was used to measure the calcium elution amount.

### (1-4) Evaluation of Oxidation Induction Time (OIT)

The oxidation induction times (OIT) of the above elbows were measured using a differential scanning calorimeter (DSC). DSC 7020, manufactured by Seiko Instruments Inc., was used for the measurements. After placing 15 mg of a cut piece of the elbows in the furnace of the device, the inner lid was closed, and the temperature was raised to 210° C. at a temperature raising rate of 20° C./min while nitrogen gas was flown at a rate of 50 mL/min, and then left in the same state for 5 minutes. After standing still, nitrogen was switched to oxygen to oxidize the sample. The oxidation induction time was measured by calculating the period from the time at which the nitrogen was switched to oxygen to the onset of the exothermic peak due to oxidation. The standard value to be met for the oxidation induction time was set at 20 minutes or longer.

### (1-5) Hot Internal Pressure Creep Test

The test was performed in accordance with the POLITEC standard (PTC K 03:2010 “Polyethylene Pipes for Water Distribution”). The elbow was filled with water, the end was fastened with a sealing jig, and the elbow was then immersed in a hot water bath at 80° C. The elbow was then still stood while loading a circumferential stress of 5.0 MPa.

TABLE 4

| | | | Examples | |
|---|---|---|---|---|
| | | | 5 | 6 |
| Sample Shape | | | Elbow | Elbow |
| Formulation | Calcium concentration (ppm) | | 37.4 | 27.6 |
| | Phenolic | Type | Irganox 1330 | Irganox 1330 |
| | antioxidant | Added | 1000 | 1000 |
| | | part (ppm) | | |

| | | | |
|---|---|---|---|
| Performance | Calcium elution amount | 1.0 | 1.1 |
| | (μg/m²) | | |
| | Oxidation induction | 34.8 | 31.1 |
| | time at 210° C. (min) | | |
| | Hot internal pressure | No fracture | No fracture |
| | creep at 80° C. and 5.0 MPa | for 3,000 hrs | for 3,000 hrs |

As shown in the table above, when pipeline members were molded using polyethylene-based resin compositions with the calcium concentration of 10 ppm or more and 60 ppm or less, the calcium elution amounts were less than 15 μg/m², which indicated that calcium elution could be effectively suppressed, and thermal stability could also be exhibited.

The hot internal pressure creep performance of the pipeline member at 80° C. and 5.0 MPa was found to show no fracture for 3,000 hours. This is thought to be because the Ziegler catalyst remaining in the resin composition after polymerization of the polyethylene-based resin composition was sufficiently neutralized, resulting in the development of long-term strength.

### (2) Evaluation of Pipe

### (2-1) Molding of Pipe

According to the formulation shown in (Table 5), a pipe with an outer diameter of 32 mm and a thickness of 3 mm was extruded. Pipes are formed by a normal molding method.

### (2-2) Evaluation of Calcium Concentration

A 0.1-g weight test specimen was prepared by cutting the above pipes, and then fed to a microwave decomposition system (MARS 6, manufactured by CEM Corp.) with 6 mL of nitric acid to decompose the test specimen by microwave irradiation. After decomposition, 1 mL of hydrogen peroxide was added, and ultrapure water was further added to adjust the volume to 25 mL. The calcium concentration of the solution was measured by an ICP apparatus (SPS 5100, manufactured by SII Technology Inc.), and the calcium concentration of the polyethylene-based resin pipe was calculated.

### (2-3) Evaluation of Calcium Elution Amount

After the sample washing of the above pipe with ultrapure water according to the method based on the SEMI F40 standard, 90 mL of ultrapure water was placed in the pipe, and the end was sealed. The pipes were then allowed to stand at 85° C.±5° C. for 7 days for elution, and then an ICP-MS device (model No. Agirent 7500cs, manufactured by Agilent Technologies) was used to measure the calcium elution amount.

### (2-4) Evaluation of Oxidation Induction Time (OIT)

The oxidation induction times (OIT) of the above pipes were measured using a differential scanning calorimeter (DSC). DSC 7020, manufactured by Seiko Instruments Inc., was used for the measurements. After placing 15 mg of a cut piece of the pipe inner layer in the furnace of the device, the inner lid was closed, and the temperature was raised to 210° C. at a temperature raising rate of 20° C./min while nitrogen gas was flown at a rate of 50 mL/min, and then left in the same state for 5 minutes. After standing still, nitrogen was switched to oxygen to oxidize the sample. The oxidation induction time was measured by calculating the period from the time at which the nitrogen was switched to oxygen to the onset of the exothermic peak due to oxidation. The standard value to be met for the oxidation induction time was set at 20 minutes or longer.

### (2-5) Hot Internal Pressure Creep Test

The test was performed in accordance with the POLITEC standard (PTC K 03:2010 “Polyethylene Pipes for Water Distribution”). The pipe was filled with water, the end was fastened with a sealing jig, and the pipe was then immersed in a hot water bath at 80° C. The pipe was then still stood in the hot water bath while loading a circumferential stress of 5.0 MPa.

TABLE 5

| | | | | Examples | |
|---|---|---|---|---|---|
| | | | | 7 | 8 |
| | | | | Pipe | Pipe |
| Sample Shape | | | | (Single layer) | (Two layers) |
| Formulation | Innermost | Calcium concentration (ppm) | | 37.3 | 40.7 |
| | layer | Phenolic | Type | Irganox 1330 | Irganox 1330 |
| | | antioxidant | Added | 1000 | 1000 |
| | | | part (ppm) | | |

| | | | |
|---|---|---|---|
| Outer layer | Calcium concentration (ppm) | — | 68.4 |

| | | | |
|---|---|---|---|
| Phenolic | Type | — | Irganox 1010 |
| antioxidant | Added | — | 1000 |
| | part (ppm) | | |

| | | | |
|---|---|---|---|
| Thickness of | Innermost layer (mm) | 3.0 | 0.5 |
| layer | Outer layer (mm) | — | 2.5 |
| Performance | Calcium elution amount | 1.2 | 2.8 |
| | (μg/m²) | | |
| | Oxidation induction | 36.5 | 29.6 |
| | time at 210° C. (min) | | |
| | Hot internal pressure | No fracture | No fracture |
| | creep at 80° C. and 5.0 MPa | for 3,000 hrs | for 3,000 hrs |

As shown in the table above, when pipeline members were molded using polyethylene-based resin compositions with the calcium concentration of 10 ppm or more and 60 ppm or less, the calcium elution amounts were less than 15 μg/m², which indicated that calcium elution could be effectively suppressed, and thermal stability could also be exhibited. The hot internal pressure creep performance of the pipeline member at 80° C. and 5.0 MPa was found to show no fracture for 3,000 hours. This is thought to be because the Ziegler catalyst remaining in the resin composition after polymerization of the polyethylene-based resin composition was sufficiently neutralized, resulting in the development of long-term strength.

### [Examples 9 to 13], [Comparative Examples 3 to 8]

Polyethylene-based resin compositions of (Table 6) and (Table 7) were prepared according to Example 1, and the following evaluations were performed.

### (4) Molding of Pipe

Pipes with an outside diameter of 110 mm and a thickness of 10 mm were molded according to the polyethylene-based resin compositions shown in (Table 6) and (Table 7). Pipes are molded by a normal molding method.

Examples 10 to 13 and Comparative Examples 3 to 8 were produced by using the same catalyst, the same polymerization process, the same α-olefin, and the same additives as in Example 9 (similarly to Table 1) and an additive of Example 3 and adjusting the hydrogen content, α-olefin content, and the component proportions such that only the resin composition should be those shown in (Table 6) and (Table 7).

### (5) Evaluation of Slow Crack Growth

The notch pipe test was performed in accordance with ISO 13479 at a test temperature of 80° C. and a test pressure of 9.2 bar. (Table 6) and (Table 7) show the test results.

### (6) Evaluation of Pipe Inner Surface Smoothness

The molded pipe was split in half, and the inner surface condition was observed. The condition with no luster due to visually obvious unevenness was designated as “X”, the condition with some degree of luster was designated as “0”, and the condition with a good luster was designated as “0”. (Table 6) and (Table 7) show the test results.

### (7) Judgment of Pipe

If a sample shows the result that the notch pipe test for evaluating slow crack growth was “>500 hours” and the evaluation on the pipe inner surface smoothness was “0 to 0”, the sample was ranked as “appropriate”, and if not, ranked as “inappropriate”.

TABLE 6

| | | | Examples | | | | |
|---|---|---|---|---|---|---|---|
| | | Unit | 9 | 10 | 11 | 12 | 13 |
| High-molecular | MFR_{21.6} | g/10 min | 0.2 | 0.1 | 0.2 | 0.4 | 0.2 |
| weight | α-olefin | mol % | 1.2 | 1.5 | 1.1 | 1.5 | 1.1 |
| component (A) | content | | | | | | |
| | Blending | wt % | 40 | 35 | 45 | 48 | 45 |
| | ratio | | | | | | |
| Low-molecular | MFR₂ | g/10 min | 130 | 100 | 100 | 80 | 150 |
| weight | α-olefin | mol % | 0.1 | 0.1 | 0.1 | 0.1 | 0.3 |
| component (B) | content | | | | | | |
| | Blending | wt % | 60 | 65 | 55 | 52 | 55 |
| | ratio | | | | | | |
| Total | MFR₅ | g/10 min | 0.4 | 0.4 | 0.2 | 0.3 | 0.2 |
| | MFR_{21.6} | g/10 min | 18 | 16 | 8 | 10 | 9 |
| | FR | — | 45 | 40 | 40 | 33 | 45 |
| | Density | g/cm³ | 0.951 | 0.947 | 0.950 | 0.946 | 0.946 |
| | α-olefin | mol % | 0.5 | 0.6 | 0.5 | 0.7 | 0.7 |
| | content | | | | | | |

| | | | | | | |
|---|---|---|---|---|---|---|
| Notch pipe test | Time | >1000 | >1000 | >1000 | >1000 | >1000 |
| Evaluation of Pipe Inner | — | ⊙ | ⊙ | ◯ | ◯ | ◯ |
| Surface Smoothness | | | | | | |
| Judgment of pipe | — | Appropriate | Appropriate | Appropriate | Appropriate | Appropriate |

TABLE 7

| | | | Comparative Examples | | | | | |
|---|---|---|---|---|---|---|---|---|
| | | Unit | 3 | 4 | 5 | 6 | 7 | 8 |
| High- | MFR_{21.6} | g/10 min | 0.2 | 1.2 | 0.1 | 0.1 | 0.2 | 3 |
| molecular | α-olefin | mol % | 0.5 | 1.4 | 1.5 | 1.5 | 1.1 | 1.1 |
| weight | content | | | | | | | |
| component | Blending | wt % | 40 | 50 | 30 | 45 | 45 | 50 |
| (A) | ratio | | | | | | | |
| Low- | MFR₂ | g/10 min | 130 | 100 | 100 | 600 | 15 | 4 |
| molecular | α-olefin | mol % | 0.2 | 0.1 | 0.1 | <0.1 | 0.1 | 0.1 |
| weight | content | | | | | | | |
| component | Blending | wt % | 60 | 50 | 70 | 55 | 55 | 50 |
| (B) | ratio | | | | | | | |
| Total | MFR₅ | g/10 min | 0.4 | 0.7 | 0.7 | 0.3 | 0.1 | 1.0 |
| | MFR_{21.6} | g/10 min | 18 | 24 | 25 | 17 | 4 | 20 |
| | FR | — | 45 | 34 | 36 | 57 | 40 | 20 |
| | Density | g/cm³ | 0.950 | 0.947 | 0.950 | 0.948 | 0.948 | 0.946 |
| | α-olefin | mol % | 0.5 | 0.6 | 0.5 | 0.6 | 0.5 | 0.6 |
| | content | | | | | | | |

| | | | | | | | |
|---|---|---|---|---|---|---|---|
| Notch pipe test | Time | <200 | <200 | <200 | <100 | >1000 | <100 |
| Evaluation of Pipe Inner | — | ⊙ | ⊙ | ⊙ | X | X | ⊙ |
| Surface Smoothness | | | | | | | |
| Judgment of pipe | — | Inappropriate | Inappropriate | Inappropriate | Inappropriate | Inappropriate | Inappropriate |

As shown in the above table, the pipes molded using the polyethylene-based resin composition in the present invention satisfied both slow crack resistance and inner surface smoothness at the same time, while pipes molded using a polyethylene-based resin composition other than that of the present invention were difficult to achieve both slow crack resistance and the inner surface smoothness. The polyethylene-based resin compositions of Examples 9 to 13 were used to formulate antioxidants using the formulations of Examples 1 or 3, and their performance was evaluated. As a result, the performances such as the calcium elution amount and oxidation induction time at 210° C. were similar to those in Examples 1 or 3, and good and excellent pipeline members for ultrapure water could be produced.

### REFERENCE SIGNS LIST

10, 11 Pipe
10a, 11a Inner surface
10b, 11b Outer surface
21 Polyethylene-based resin layer (one example of the layer)
22 Coated resin layer

1. A pipeline member for ultrapure water, comprising a layer that contains a polyethylene-based resin as a major component,
the layer forming a pipeline member inner surface, and
the layer having a calcium concentration of 10 ppm or more and 60 ppm or less.

2. The pipeline member for ultrapure water according to claim 1, wherein
the polyethylene-based resin is a polyethylene-based resin polymerized using a Ziegler catalyst.

3. The pipeline member for ultrapure water according to claim 1, wherein
the layer contains an antioxidant.

4. The pipeline member for ultrapure water according to claim 3, wherein the antioxidant includes a phenolic antioxidant free of oxygens derived from anything other than phenol groups.

5. The pipeline member for ultrapure water according to claim 3, wherein
the antioxidant includes a phenolic antioxidant containing oxygen derived from anything other than phenol groups, and
the layer has a calcium concentration of 50 ppm or less.

6. The pipeline member for ultrapure water according to claim 1, wherein
the layer is substantially free of photostabilizers.

7. The pipeline member for ultrapure water according to claim 1, wherein
the layer shows an oxidation induction time at 210° C. of 20 minutes or longer.

8. The pipeline member for ultrapure water according to claim 1, wherein
a total organic carbon amount eluted from the layer is 30000 μg/m² or less.

9. The pipeline member for ultrapure water according to claim 1, wherein
the layer has a thickness of 0.3 mm or larger.

10. The pipeline member for ultrapure water according to claim 1, wherein
the layer has a thickness of 2.0 mm or smaller.

11. The pipeline member for ultrapure water according to claim 1,
which does not cause destruction for 3,000 hours or longer in a state where circumferential stress of 5.0 MPa is applied to the pipeline member for ultrapure water at 80° C.

12. A polyethylene-based resin composition for a pipeline member for ultrapure water, comprising a polyethylene-based resin and satisfying following characteristics (1) to (5):
characteristic (1): a melt flow rate (MFR_{21.6}) at a temperature of 190° C. and a load of 21.6 kg being 6 g/10 min or more and 25 g/10 min or less;
characteristics (2): FR (MFR_{21.6}/MFR₅), i.e., a ratio of MFR_{21.6} to a melt flow rate (MFR₅) at a load of 5 kg, being 25 or more and 60 or less;
characteristics (3): a high molecular weight component (A) and a low molecular weight component (B) being included, the high molecular weight component (A) showing an MFR_{21.6} of 0.05 g/10 min or more and 1.0 g/10 min or less, an α-olefin content that excludes ethylene being 0.8 mol % or more and 2.0 mol % or less and a content proportion of α-olefins that excludes ethylene in relation to the entire resin being 35 wt % or more and 50 wt % or less, the low molecular-weight component (B) showing a melt flow rate (MFR_{2.16}) at a temperature of 190° C. and a load of 2.16 kg of 20 g/10 min or more and 500 g/10 min or less;
characteristics (4): a density being 0.946 g/cm³ or more and 0.960 g/cm³ or less; and
characteristics (5): a calcium concentration being 10 ppm or more and 60 ppm or less.

13. The polyethylene-based resin composition for a pipeline member for ultrapure water according to claim 12, wherein
the polyethylene-based resin is a polyethylene-based resin polymerized using a Ziegler catalyst.

14. The polyethylene-based resin composition for a pipeline member for ultrapure water according to claim 12,
which contains an antioxidant.

15. The polyethylene-based resin composition for a pipeline member for ultrapure water according to claim 14, wherein
the antioxidant includes a phenolic antioxidant free of oxygens derived from anything other than phenol groups.

16. The polyethylene-based resin composition for a pipeline member for ultrapure water according to claim 14, wherein
the antioxidant includes a phenolic antioxidant containing oxygen derived from anything other than phenol groups, and
a calcium concentration is 50 ppm or less.

17. The polyethylene-based resin composition for a pipeline member for ultrapure water according to claim 12,
which is substantially free of photostabilizers.

18. The polyethylene-based resin composition for a pipeline member for ultrapure water according to claim 12,
which shows an oxidation induction time at 210° C. of 20 minutes or longer.
